(19) United States
(12) Patent Application Publication
(10) Pub. No.: US 2014/0082007 A1
(43) Pub. Date: Mar. 20, 2014

(54) METHOD, SYSTEM AND STORAGE MEDIUM FOR PUSHING USER'S PERSONAL LABEL DYNAMICALLY

(71) Applicant: Tencent Technology (Shenzhen) Company Limited, Shenzhen (CN)

(72) Inventor: Yu Ku, Shenzhen (CN)

(73) Assignee: Tencent Technology (Shenzhen) Company Limited, Shenzhen (CN)

(21) Appl. No.: 14/082,598

(22) Filed: Nov. 18, 2013

Related U.S. Application Data
(63) Continuation of application No. PCT/CN2012/073428, filed on Mar. 31, 2012.

(30) Foreign Application Priority Data
May 19, 2011 (CN) CN 201110130641.5

(51) Int. Cl. G06F 17/30

(52) U.S. Cl. CPC G06F 17/30386
USPC 707/758

(57) ABSTRACT

Disclosed in the present invention are a method, system and storage medium for pushing the user's personal label dynamically, which is applied to the communication field. Said method comprises the following steps: collecting user's behavior information about network operation; extracting the keywords from said behavior information; pushing the extracted keywords as the user's personal label to the user. The present invention can show user's new interests and hotspot news focused in time by updating the user's personal label dynamically, thus enhancing user's satisfaction effectively.

### CROSS-REFERENCES TO RELATED APPLICATIONS

This application claims priority and is a continuation of PCT/CN2012/073428, filed on Mar. 31, 2012 and entitled “METHOD, SYSTEM AND STORAGE MEDIUM FOR PUSHING USER′S PERSONAL LABEL DYNAMICALLY”, which claims the benefit of Chinese Patent Application No. 201110130641.5, filed with the Chinese Patent Office on May 19, 2011 and entitled “METHOD, SYSTEM AND STORAGE MEDIUM FOR PUSHING USER'S PERSONAL LABEL DYNAMICALLY”, the contents of which are incorporated herein by reference in their entirety.

### FIELD OF THE INVENTION

The invention belongs to the field of communication, and particularly relates to a method, system and storage medium for pushing a user personal label of a user dynamically.

### BACKGROUND OF THE INVENTION

With the development of communication technology, the network instant communication tool (such as QQ, MSN or MICRO-BLOG) is applied more and more widely, and has become an indispensable communication tool in people's daily work and life.

### SUMMARY OF THE INVENTION

An object of an embodiment of the present invention is to provide a method for pushing a user personal label of a user dynamically, for solving the problem that the existing personal label can not be pushed dynamically based on user's behavior about network operation.

The embodiment of the invention can be implemented by the method for pushing a user personal label of a user dynamically, and the method includes:
collecting user behavior information on network operation;
extracting a keyword from the user behavior information; and
pushing the extracted keyword as the user personal label to the user.

Another object of the embodiment of the invention is to provide a system for pushing a user personal label of a user dynamically, and the system includes:
an information collecting unit, adapted to collect user behavior information on network operation;
a keyword extracting unit, adapted to extract a keyword from the user behavior information; and
a label pushing unit, adapted to push the extracted keyword as the user personal label to the user.

Yet another object of the embodiment of the invention is to provide one or more storage mediums in which executable instructions are contained, wherein the executable instructions are adapted to implement a method for pushing a user personal label of a user, and the method includes:
collecting user behavior information on network operation;
extracting a keyword from the user behavior information; and
pushing the extracted keyword as the user personal label to the user.

In the embodiment of the invention, the user personal label can be updated dynamically by extracting a keyword from the user behavior information on network operation and pushing the extracted keyword as the user personal label to the user, and the user's new interests and hotspot information focused can be shown in time through the updated personal label, thus user's satisfaction is enhanced effectively.

### BRIEF DESCRIPTION OF THE DRAWINGS

FIG. 1 is an implementation flow chart of a method for pushing a user personal label of a user dynamically according to a first embodiment of the present invention;

FIG. 2 is a specific flow chart of pushing a extracted keyword as a user personal label to a user according to the first embodiment of the present invention;

FIG. 3 is an implementation flow chart of a method for pushing a user personal label of a user dynamically according to a second embodiment of the present invention;

FIG. 4 is a specific flow chart of a reusable page sub-element control management method according to the second embodiment of the present invention;

FIG. 5 is a structural block diagram of a system for pushing a user personal label of a user dynamically according to a third embodiment of the present invention;

FIG. 6 is a structural block diagram of a system for pushing a user personal label of a user dynamically according to a fourth embodiment of the present invention; and

FIG. 7 is a structural block diagram of a container shift-in module according to a fifth embodiment of the present invention.

### DETAILED DESCRIPTION OF THE INVENTION

Hereinafter, the invention will be described further in detail in conjunction with the accompanying drawings and embodiments in order to make the object, technical solution and advantages of the invention more clear. It should be understood that the specific embodiments described here are only for explaining the invention, but are not intended to limit the invention.

A personal label of the network instant communication tool is a keyword for describing user's interests, personalization features and the like. With these personal labels, the rapid understanding among users can be facilitated, and a user can also search for users who have the same interests as the user.

While, in the existing client of a network instant communication tool, the user personal label needs to be added, modified or deleted by the user manually, and no corresponding keyword can be extracted based on the user's behavior about network operation (for example: the information published by the user, the information focused by the user) as the user personal label to be pushed dynamically.

In an embodiment of the present invention, a user personal label can be updated dynamically by extracting a keyword from user behavior information on network operation and pushing the extracted keyword as the user personal label to the user, and the user's new interest and hotspot information focused can be shown in time through the updated personal label, thus user's satisfaction is enhanced effectively.

The technical solution according to the present invention will be described in the following by way of specific embodiments.

### First Embodiment

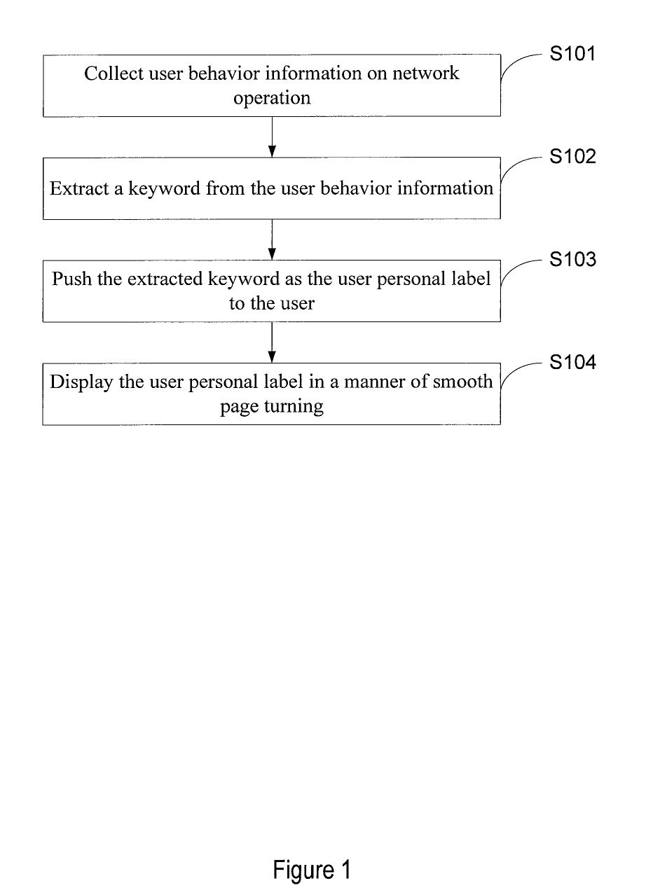

FIG. 1 shows an implementation flowchart of a method for pushing a user personal label of a user dynamically according to the first embodiment of the present invention, and the procedure of the method is described as follow.

In step S101, collecting user behavior information on network operation.

In the embodiment, a server monitors the user behavior information on network operation in real time. The behavior information includes, but is not limited to, information published on MICRO-BLOG, TALK or LOG and the like by the user and the information clicked and focused high frequently by the user currently, such as “housing price”, “telephone booking” and the like hotspot information. Furthermore, when the user behavior information on network operation changes, the changed behavior information is collected.

In step S102, extracting a keyword from the user behavior information.

In the embodiment, text mining is performed for the collected user behavior information to extract the keyword. Herein, a keyword extracting algorithm can be employed for the text mining. Specifically, firstly the text information of the user behavior information is detached into words and the number (T) of occurrences of each word is stored; the weight value (D) of each word is obtained by querying and then each multiplied by the number of occurrences of each word; the words are sorted by D*T value and the top few words are extracted as keywords.

Practically, for those skilled in the art, it is easy to know that other text mining technologies can also be employed to extract the keywords.

In step S103, pushing the extracted keyword as the user personal label to the user.

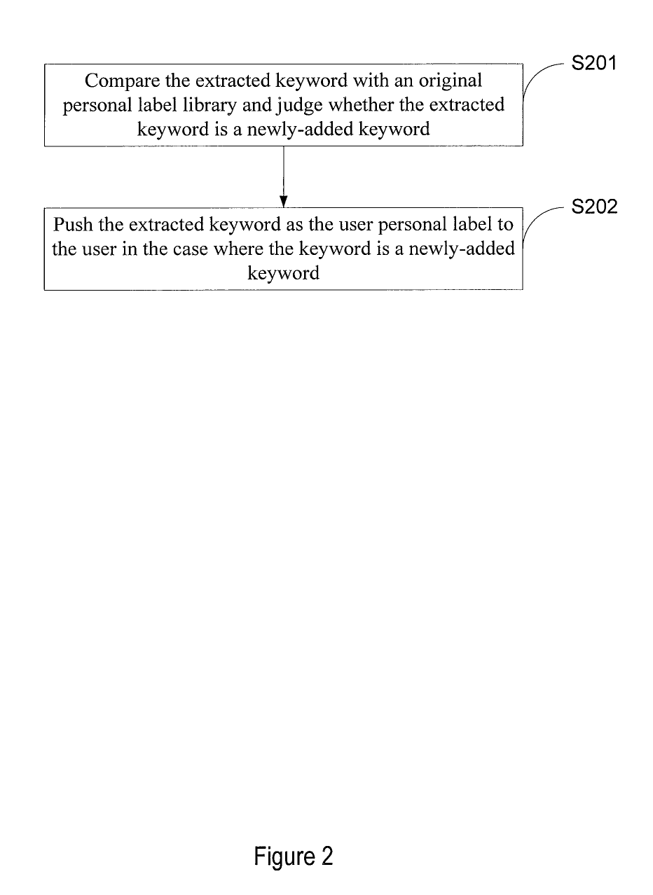

In the embodiment, the specific procedure of pushing the keyword as the user personal label to the user is shown in FIG. 2.

In step S201, the extracted keyword is compared with an original personal label library and it is judged whether the extracted keyword is a newly-added keyword;

In step 5202, the extracted keyword as the user personal label is pushed to the user in the case where the extracted keyword is a newly-added keyword.

In the embodiment, a personal label is a keyword for describing user's interests, personalization features and the like. Before being updated, the personal label library is an original personal label library, and the original personal label library is packaged into an installation package in the form of configuration file. Each time when a user logins the network instant communication tool, all the extracted keywords are traversed, the extracted keyword are compared with the original personal label library and it is judged whether the extracted keywords are newly-added keywords, i.e., whether the keywords are present in the original personal label library, and in the case where the keywords are not present in the original personal label library, the original personal label library is updated, i.e., the newly-added keywords as the user's new personal label are added into the original personal label library, and the new personal label is pushed to the user in the manner of interface display.

In the embodiment of the present invention, the user personal label can be updated dynamically by extracting a keyword from the user behavior information on network operation and pushing the extracted keyword as the user personal label to the user, and the user's new interests and hotspot information focused can be shown in time through the updated personal label, thus user's satisfaction is enhanced effectively.

### Second Embodiment

Further, in order to improve the user's visual experience, as a preferred embodiment of the present invention, the method further includes a step S104 after the step S103.

In step S104, displaying the user personal label in a manner of smooth page turning.

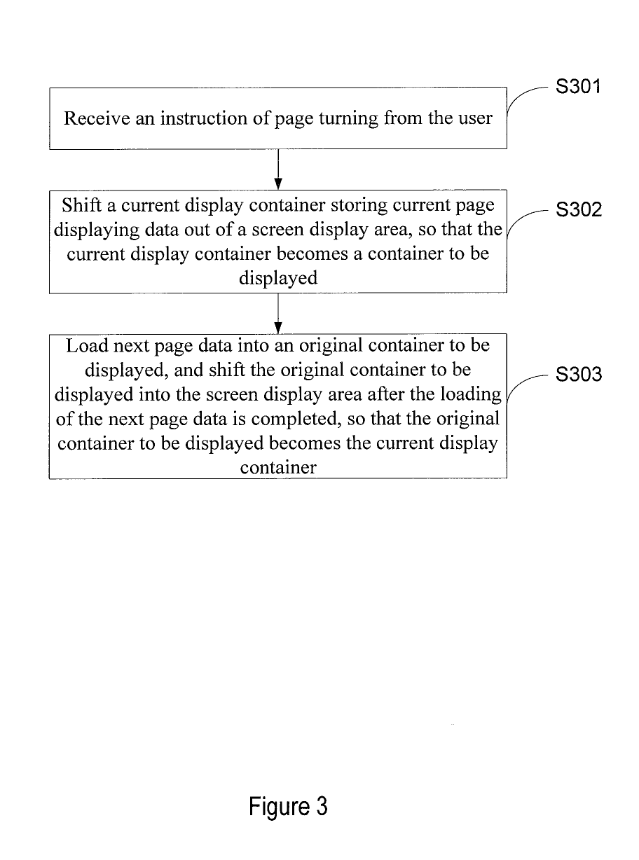

In the embodiment, in order to implement the effect of displaying the user personal label in a manner of smooth page turning, two background internal container controls can be divided into a current display container and a container to be displayed for displaying data alternately, and specific steps are shown in FIG. 3.

In step S301, receiving an instruction of page turning from the user;

In step S302, shifting the current display container in which current page displaying data is stored out of a screen display area, so that the current display container becomes the container to be displayed;

In step S303, loading next page data into the original container to be displayed, and shifting the original container to be displayed into the screen display area after the loading of the next page data is completed, so that the original container to be displayed becomes the current display container.

In the embodiment, after the instruction of page turning (i.e., clicking the next page) is received from the user, background program shifts the current display container out of the screen display area (the current display container stores the current page data displaying information), and after the current display container is shifted out of the screen display area, the current display container becomes the container to be displayed for waiting for the loading and displaying of the next page data. The next page data information is loaded into the original container to be displayed, and after the loading of the next page data information is completed, the original container to be displayed is shifted into the screen display area, and the original container to be displayed becomes the current display container for displaying the page data information, herein, the loaded page data information includes, but is not limited to, user personal label information.

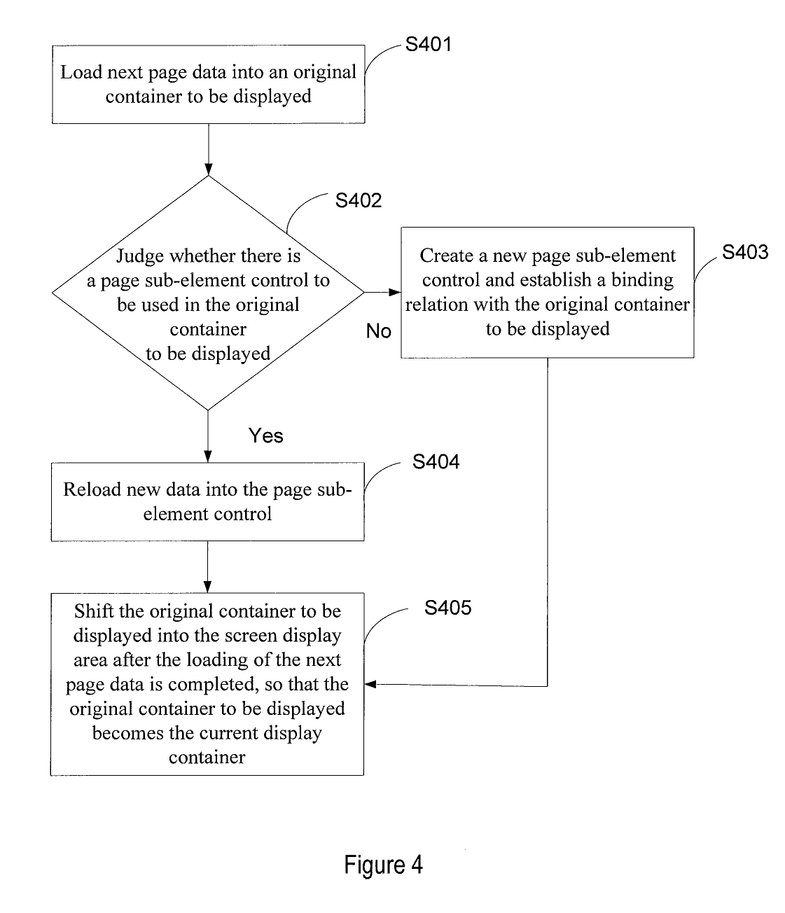

As an embodiment of the present invention, if there are too many user personal labels, the creations of the page sub-element controls as smooth page turning are reduced by the reusable page sub-element control management method, and the specific procedure is shown in FIG. 4.

In step S401, loading next page data into the original container to be displayed;

In step S402, judging whether there is a page sub-element control to be used in the original container to be displayed. If the judging result is “Yes”, performing step S404, else if the judging result is “No”, performing step S403;

In the embodiment, a list of page sub-element controls to be used is maintained in each container, when the page data is loaded into the container to be displayed, firstly it is found whether there is a page sub-element control to be used in the list, if there is a page sub-element control to be used, it only needs to reload new data into the page sub-element control; if there is no page sub-element control to be used, a new page sub-element control is created, and a binding relation with the original container to be displayed is established.

In step S403, creating a new page sub-element control, and establishing a binding relation with the original container to be displayed;

In step S404, reloading new data into the page sub-element control;

In step S405, shifting the original container to be displayed into the screen display area after the loading of the new data is completed; so that the original container to be displayed becomes the current display container.

In the embodiment, after the loading of the page data is completed, all the page sub-element controls in the page data loaded container are traversed and all the page sub-element controls are added into the list of page sub-element controls to be used to facilitate the reuse of the page sub-element control when page data is loaded next time.

In the embodiment of the present invention, by the page sub-element control management method, the creations of the page sub-element controls when the page is loaded are reduced effectively, thus the memory usage of the system is reduced and the performance of the system is improved.

### Third Embodiment

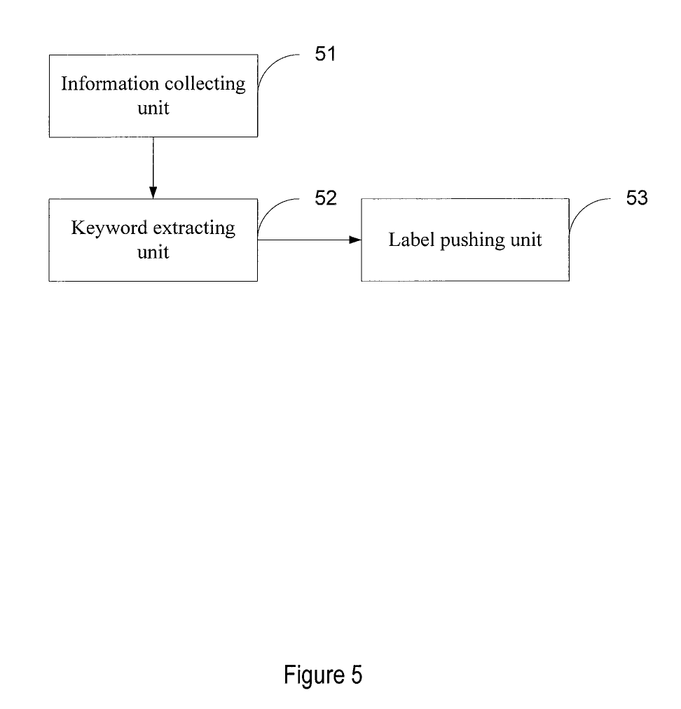

FIG. 5 shows a structure of a system for pushing a user personal label of a user dynamically according to the third embodiment of the present invention, in which only the parts related to the embodiment of the invention are shown for convenience of explanation.

The system for pushing a user personal label of a user dynamically can be used for various communication terminal, such as handheld computer, computer, notebook computer, and Personal Digital Assistant, connected with a server, and can be a software unit, a hardware unit or a combination unit of the software unit and hardware unit running inside these communication terminals, and can also serve as a separate pendant which is integrated into those communication terminals or runs in the application systems of these communication terminals.

The system for pushing a user personal label of a user dynamically includes an information collecting unit 51, a keyword extracting unit 52 and a label pushing unit 53. The specific function of each unit is as follow.

The information collecting unit 51 is adapted to collect user behavior information or current hotspot information, the implementation thereof is described as above, and is not described again here.

The keyword extracting unit 52 is adapted to extract a keyword from the collected user behavior information or the current hotspot information, the implementation thereof is described as above, and is not described again here.

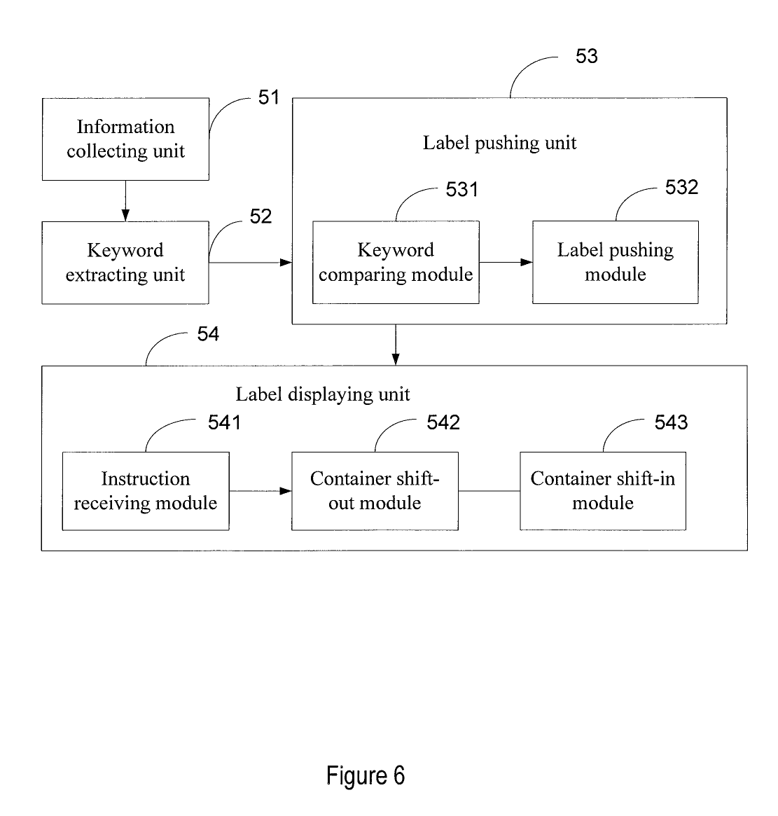

The label pushing unit 53 is adapted to push the extracted keyword as the user personal label to the user. Herein, in an embodiment, as shown in FIG. 6, the label pushing unit 53 further includes a keyword comparing module 531 and a label pushing module 532. The specific function of each module is as follow.

The keyword comparing module 531 is adapted to compare the extracted keyword with an original personal label library and judge whether the extracted keyword is a newly-added keyword.

The label pushing module 532 is adapted to push the extracted keyword as the user personal label to the user in the case where the keyword is a newly-added keyword.

In the embodiment, a personal label is a keyword for describing user's interests, personalization features and the like. Before being updated, the personal label library is an original personal label library, and the original personal label library is packaged into an installation package in the form of configuration file. Each time when a user logins the network instant communication tool, all the extracted keywords are traversed, the keywords are compared with the original personal label library and it is judged whether the extracted keywords are newly-added keywords, i.e., whether the keywords are present in the original personal label library, and in the case where the keywords are not present in the original personal label library, the original personal label library is updated, i.e., the newly-added keywords as the user's new personal label are added into the original personal label library, and the new personal label is pushed to the user in the manner of interface display.

Further, in order to improve the user's visual experience, as shown in FIG. 6, as a preferred embodiment of the present invention, the system for pushing a user personal label of a user dynamically further includes a label displaying unit 54 adapted to display the user personal label in a manner of smooth page turning.

In the embodiment, in order to implement the effect of displaying the user personal label by way of smooth page turning, two background internal container controls can be divided into a current display container and a container to be displayed for displaying data alternately, and the label displaying unit 54 further includes a instruction receiving module 541, a container shift-out module 542 and a container shift-in module 543. The specific function of each module is as follow.

The instruction receiving module 541 is adapted to receive an instruction of page turning from the user.

The container shift-out module 542 is adapted to shift a current display container storing current page displaying data out of the screen display area, so that the current display container becomes the container to be displayed.

The container shift-in module 543 is adapted to load next page data into an original container to be displayed, and shift the original container to be displayed into the screen display area after the loading of the next page data is completed, so that the original container to be displayed becomes the current display container.

In the embodiment, after the instruction of page turning (i.e., clicking the next page) is received from the user, background program shifts the current display container out of the screen display area (the current display container stores the current page data displaying information), and after the current display container is shifted out of the screen display area, the current display container becomes the container to be displayed for waiting for the loading and displaying of the next page data. The next page data information is loaded into the original container to be displayed, and after the loading of the next page data information is completed, the original container to be displayed is shifted into the screen display area, and the original container to be displayed becomes the current display container for displaying the page data information. Herein, the loaded page data information includes, but is not limited to, user personal label information.

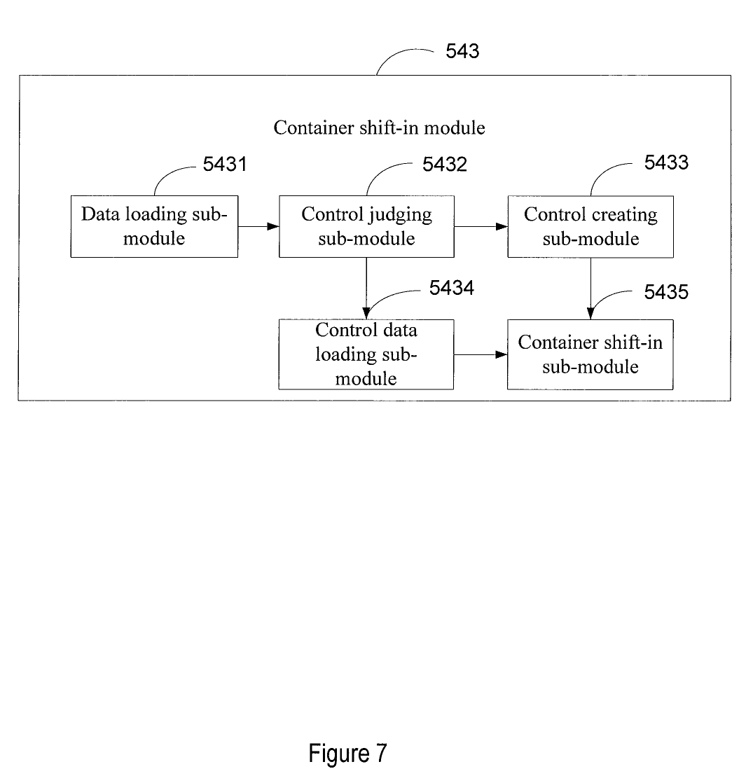

As shown in FIG. 7, as an embodiment of the present invention, in order to reduce the creations of the page sub-element controls when the page is loaded, for reducing the memory usage of the system and improving the performance of the system, the container shift-in module 543 further includes a data loading sub-module 5431, a control judging sub-module 5432, a control creating sub-module 5433 and a control data loading sub-module 5434. The specific function of each module is as follow.

The data loading sub-module 5431 is adapted to load next page data into an original container to be displayed.

The control judging sub-module 5432 is adapted to judge whether there is a page sub-element control to be used in the original container to be displayed. If the judging result is “Yes”, the control data loading sub-module 5434 reloads new data into the page sub-element control, else if the judging result is “No”, the control creating sub-module 5433 creates a new page sub-element control and establishes a binding relation with the original container to be displayed.

A container shift-in sub-module 5435 is adapted to shift the original container to be displayed into the screen display area after the loading of the next page data is completed, so that the original container to be displayed becomes the current display container.

In the embodiment, the specific implementation thereof are described as above, and are not described again here.

In the embodiment of the present invention, the user personal label can be updated dynamically by extracting a keyword from the user behavior information on network operation and pushing the extracted keyword as the user personal label to the user, and the user's new interests and hotspot information focused can be shown in time through the updated personal label, thus user's satisfaction is enhanced effectively. Furthermore, in order to improve the user's visual experience, the user personal label is displayed in a manner of smooth page turning; further, in order to reduce the memory usage of the system and improve the performance of the system, the creations of the page sub-element controls as smooth page turning are reduced effectively by the reusable page sub-element control management method.

The above are only preferred embodiments of the invention, and are not intended to limit the invention. Any modifications, equivalent replacements and improvements within the spirit and principle of the invention should be included in the scope of protection of the invention.

What is claimed is:

1. A method for pushing a user personal label of a user dynamically, comprising:
collecting user behavior information on network operation;
extracting a keyword from the user behavior information; and
pushing the extracted keyword as the user personal label to the user.

2. The method according to claim 1, wherein the pushing the extracted keyword as the user personal label to the user comprises:
comparing the extracted keyword with an original personal label library, and judging whether the extracted keyword is a newly-added keyword; and
pushing the extracted keyword as the user personal label to the user in the case where the keyword is a newly-added keyword.

3. The method according to claim 1, wherein the method further comprises:
displaying the user personal label in a manner of smooth page turning.

4. The method according to claim 3, wherein the displaying the user personal label in a manner of smooth page turning comprises:
receiving an instruction of page turning from the user;
shifting a current display container storing current page displaying data out of a screen display area, so that the current display container becomes a container to be displayed; and
loading next page data into an original container to be displayed, and shifting the original container to be displayed into the screen display area after the loading of the next page data is completed, so that the original container to be displayed becomes the current display container.

5. The method according to claim 4, wherein the loading next page data into an original container to be displayed, and shifting the original container to be displayed into the screen display area after the loading of the next page data is completed, so that the original container to be displayed becomes the current display container, comprises:
loading the next page data into the original container to be displayed;
judging whether there is a page sub-element control to be used in the original container to be displayed;
creating a new page sub-element control and establishing a binding relation with the original container to be displayed in the case where there is no page sub-element control to be used in the original container to be displayed;
reloading the next page data into the page sub-element control in the case where there is a page sub-element control to be used in the original container to be displayed; and
shifting the original container to be displayed into the screen display area after the loading of the next page data is completed, so that the original container to be displayed becomes the current display container.

6. A system for pushing a user personal label of a user dynamically, comprising:
an information collecting unit, adapted to collect user behavior information on network operation;
a keyword extracting unit, adapted to extract a keyword from the user behavior information; and
a label pushing unit, adapted to push the extracted keyword as the user personal label to the user.

7. The system according to claim 6, wherein the label pushing unit further comprises:
a keyword comparing module, adapted to compare the extracted keyword with an original personal label library and judge whether the extracted keyword is a newly-added keyword; and
a label pushing module, adapted to push the extracted keyword as the user personal label to the user in the case where the keyword is a newly-added keyword.

8. The system according to claim 6, further comprising:
a label displaying unit, adapted to display the user personal label in a manner of smooth page turning.

9. The system according to claim 8, wherein the label displaying unit further comprises:
an instruction receiving module, adapted to receive an instruction of page turning from the user;
a container shift-out module, adapted to shift a current display container storing current page displaying data out of a screen display area, so that the current display container becomes a container to be displayed; and
a container shift-in module, adapted to load next page data into an original container to be displayed, and shift the original container to be displayed into the screen display area after the loading of the next page data is completed, so that the original container to be displayed becomes the current display container.

10. The system according to claim 9, wherein the container shift-in module further comprises:
a data loading sub-module, adapted to load the next page data into the original container to be displayed;
a control judging sub-module, adapted to judge whether there is a page sub-element control to be used in the original container to be displayed;
a control creating sub-module, adapted to create a new page sub-element control and establishing a binding relation with the original container to be displayed in the case where there is no page sub-element control to be used in the original container to be displayed;
a control data loading sub-module, adapted to reload the next page data into the page sub-element control in the case where there is a page sub-element control to be used in the original container to be displayed; and
a container shift-in sub-module, adapted to shift the original container to be displayed into the screen display area after the loading of the next page data is completed, so that the original container to be displayed becomes the current display container.

11. A storage medium in which executable instructions are contained, wherein the executable instructions are adapted to implement a method for pushing a user personal label of a user, and the method comprises:
collecting user behavior information on network operation;
extracting a keyword from the user behavior information; and
pushing the extracted keyword as the user personal label to the user.

12. The storage medium according to claim 11, wherein the pushing the extracted keyword as the user personal label to the user comprises:
comparing the extracted keyword with an original personal label library, and judging whether the extracted keyword is a newly-added keyword; and
pushing the extracted keyword as the user personal label to the user in the case where the keyword is a newly-added keyword.

13. The storage medium according to claim 11, wherein the displaying the user personal label in a manner of smooth page turning comprises:
receiving an instruction of page turning from the user;
shifting a current display container storing current page displaying data out of a screen display area, so that the current display container becomes a container to be displayed; and
loading next page data into an original container to be displayed, and shifting the original container to be displayed into the screen display area after the loading of the next page data is completed, so that the original container to be displayed becomes the current display container.

14. The storage medium according to claim 13, wherein the displaying the user personal label in a manner of smooth page turning comprises:
receiving an instruction of page turning from the user;
shifting a current display container in which current page displaying data is stored out of a screen display area, so that the current display container becomes a container to be displayed; and
loading next page data into an original container to be displayed, and shifting the original container to be displayed into the screen display area after the loading of the next page data is completed, so that the original container to be displayed becomes the current display container.

15. The storage medium according to claim 14, wherein the loading next page data into an original container to be displayed, and shifting the original container to be displayed into the screen display area after the loading of the next page data is completed, so that the original container to be displayed becomes the current display container, comprises:
loading the next page data into the original container to be displayed;
judging whether there is a page sub-element control to be used in the original container to be displayed;
creating a new page sub-element control and establishing a binding relation with the original container to be displayed in the case where there is no page sub-element control to be used in the original container to be displayed;
reloading the next page data into the page sub-element control in the case where there is a page sub-element control to be used in the original container to be displayed; and
shifting the original container to be displayed into the screen display area after the loading of the next page data is completed, so that the original container to be displayed becomes the current display container.
